(19) United States
(12) Patent Application Publication
(10) Pub. No.: US 2017/0137671 A1
(43) Pub. Date: May 18, 2017

(54) LONG ADHESIVE FILM

(71) Applicant: NITTO DENKO CORPORATION, Ibaraki-shi, Osaka (JP)

(72) Inventors: Daisuke Ogomi, Ibaraki-shi (JP); Masahiro Yaegashi, Ibaraki-shi (JP); Yuki Nakano, Ibaraki-shi (JP); Kota Nakai, Ibaraki-shi (JP); Yuki Ose, Ibaraki-shi (JP)

(73) Assignee: NITTO DENKO CORPORATION, Ibaraki-shi, Osaka (JP)

(21) Appl. No.: 15/322,258

(22) PCT Filed: Jun. 26, 2015
(86) PCT No.: PCT/JP2015/068501

§ 371 Date: Dec. 27, 2016

(30) Foreign Application Priority Data
Jun. 27, 2014 (JP) 2014-132577
Jun. 25, 2015 (JP) 2015-127641

(51) Int. Cl. C09J 7/02; G02B 1/14; G02B 5/30

(52) U.S. Cl. CPC C09J 7/0264; G02B 5/3033; G02B 1/14

(57) ABSTRACT

A long pressure-sensitive adhesive film, that can be suitably used as a surface protective film or mask at the time of the treatment of a predetermined portion of a long film. A pressure-sensitive adhesive film including a long resin film; and a pressure-sensitive adhesive layer arranged on one surface of the resin film. The pressure-sensitive adhesive film has through-holes that are arranged in a lengthwise direction and/or a widthwise direction at predetermined intervals, and that penetrate the resin film and the pressure-sensitive adhesive layer integrally.

### TECHNICAL FIELD

The present invention relates to a long pressure-sensitive adhesive film. More specifically, the present invention relates to a long pressure-sensitive adhesive film having through-holes arranged according to a predetermined pattern.

### BACKGROUND ART

Some of the image display apparatus of a cellular phone, a notebook personal computer (PC), and the like have mounted thereon internal electronic parts, such as a camera. Various investigations have been made for the purpose of improving, for example, the camera performance of any such image display apparatus (for example, Patent Literatures 1 to 7). However, an additional improvement in camera performance or the like has been desired in association with rapid widespread use of a smart phone and a touch panel-type information processing apparatus. In addition, a polarising plate partially having polarization performance has been required in order to correspond to the diversification of the shapes of the image display apparatus and the high-functionalization thereof. In order that those requirements may be satisfied industrially and commercially, it has been desired that the image display apparatus and/or a part thereof be produced at acceptable cost. However, there remain various matters to be investigated for establishing such technology.

### CITATION LIST

### Patent Literature

[PTL 1] JP 2011-81315 A

[PTL 2] JP 2007-241314 A

[PTL 3] DS 2004/0212555 A1

[PTL 4] KR 10-2012-0118205 A

[PTL 5] KR 10-1293210 B1

[PTL 6] JP 2012-137738 A

[PTL 7] US 2014/0118826 A1

### SUMMARY OF INVENTION

### Technical Problem

The present invention has been made to solve the above-described problems, and a primary object of the present invention is to provide a long pressure-sensitive adhesive film, that can be suitably used as a surface protective film or mask at the time of the treatment of a predetermined portion of a long film.

### Solution to Problem

A pressure-sensitive adhesive film according to an embodiment of the present invention includes: a long resin film; and a pressure-sensitive adhesive layer arranged on one surface of the resin film. The pressure-sensitive adhesive film has through-holes that are arranged in a lengthwise direction and/or a widthwise direction at predetermined intervals, and that penetrate the resin film and the pressure-sensitive adhesive layer integrally.

In one embodiment of the present invention, the through-holes are arranged in the lengthwise direction at predetermined intervals.

In one embodiment of the present invention, the through-holes are arranged in at least the lengthwise direction at substantially equal intervals.

In one embodiment of the present invention, the through-holes are arranged in the lengthwise direction and the widthwise direction at substantially equal intervals.

In one embodiment of the present invention, a direction of a straight line connecting the through-holes adjacent to each other falls within a range of ±10° with respect, to the lengthwise direction and/or the widthwise direction.

In one embodiment of the present invention, the through-holes are arranged in a dotted manner.

In one embodiment of the present invention, a plan-view shape of each of the through-holes includes a substantially circular shape or a substantially rectangular shape.

In one embodiment of the present invention, the pressure-sensitive adhesive film further includes a long separator temporarily bonded to the pressure-sensitive adhesive layer in a peelable manner.

In one embodiment of the present invention, the through-holes penetrate the separator, the resin film, and the pressure-sensitive adhesive layer integrally.

In one embodiment of the present invention, the pressure-sensitive adhesive film is wound in a roll shape.

In one embodiment of the present invention, the pressure-sensitive adhesive film is bonded to a long film so that their lengthwise directions may be aligned with each other, and is used for selectively treating portions of the film corresponding to the through-holes.

In one embodiment of the present invention, the pressure-sensitive adhesive film is used for producing a long polarizer having a non-polarization portion.

In one embodiment of the present invention, peripheral edges of the through-holes on a pressure-sensitive adhesive layer side are each formed info an arcuate surface.

### Advantageous Effects of Invention

According to the present invention, the pressure-sensitive adhesive film that is long and has through-holes arranged in a lengthwise direction and/or a widthwise direction at predetermined intervals (i.e., according to a predetermined pattern) is provided. Such pressure-sensitive adhesive film can be suitably used as, for example, a surface protective film or mask at the time of a selective treatment of a predetermined portion of a film (typically a long film). When such pressure-sensitive adhesive film is used, a continuous treatment can be performed while the long film is conveyed with rolls, and hence the treatment efficiency of each of various selective treatments can be extremely improved. Further, when such pressure-sensitive adhesive film is used, portions to be selectively treated can be arranged over the entirety of the long film under precise control. Accordingly, when final products each having a predetermined size are cut out of the long film, a variation in quality between the final products can be significantly suppressed.

### BRIEF DESCRIPTION OF DRAWINGS

FIG. 1 is a schematic perspective view of a pressure-sensitive adhesive film according to one embodiment of the present invention.

FIG. 2A is a schematic sectional view of the pressure-sensitive adhesive film of FIG. 1.

FIG. 2B is a schematic sectional view of a pressure-sensitive adhesive film according to another embodiment of the present invention.

FIG. 3A is a schematic plan view for illustrating an example of the arrangement pattern of through-holes in the pressure-sensitive adhesive film according to the embodiment of the present invention.

FIG. 3B is a schematic plan view for illustrating another example of the arrangement pattern of through-holes in the pressure-sensitive adhesive film according to the embodiment of the present invention.

FIG. 3C is a schematic plan view tor illustrating still another example of the arrangement pattern of through-holes in the pressure-sensitive adhesive film according to the embodiment of the present invention.

FIG. 4 is a schematic perspective view for illustrating bonding between the pressure-sensitive adhesive film, according to the embodiment of the present invention and a polarizer in a method of producing a polarizer including using the pressure-sensitive adhesive film.

FIG. 5 is a schematic view for illustrating the formation of non-polarization portions in the method of producing a polarizer including using the pressure-sensitive adhesive film according to the embodiment of the present invention.

FIG. 6 is an observation photograph of a state in which the pressure-sensitive adhesive film of each of Examples is bonded to a polarizer.

### DESCRIPTION OF EMBODIMENTS

Embodiments of the present invention are described below. However, the present invention is not limited to these embodiments.

A. Pressure-Sensitive Adhesive Film

### A-1. Overall Configuration of Pressure-Sensitive Adhesive Film

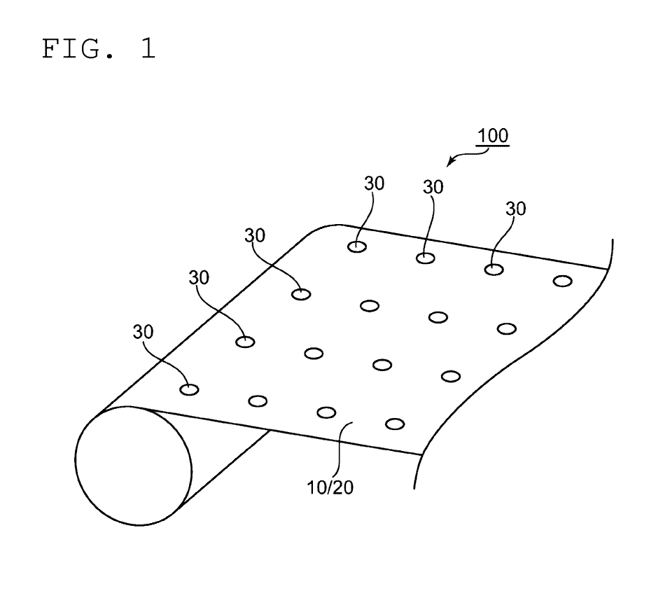

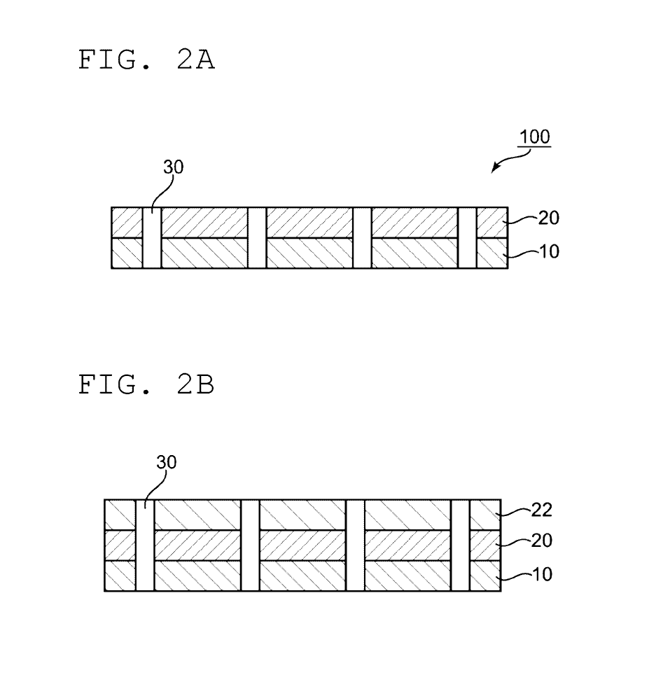

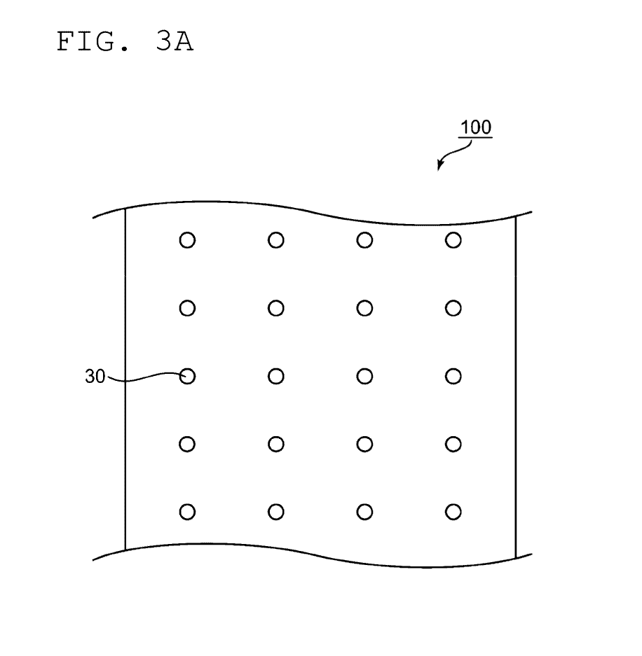

FIG. 1 is a schematic perspective view of a pressure-sensitive adhesive film according to one embodiment of the present invention. FIG. 2A is a schematic sectional view of the pressure-sensitive adhesive film. A pressure-sensitive adhesive film 100 is long and is typically wound in a roll shape as illustrated in FIG. 1. The term “long” as used herein means an elongated shape in which a length is sufficiently long as compared to a width, and includes, for example, an elongated shape in which a length is 10 or more times, preferably 20 or more times as long as a width. The pressure-sensitive adhesive film 100 includes a long resin film 10 and a pressure-sensitive adhesive layer 20 arranged on one surface of the resin film 10. The pressure-sensitive adhesive film 100 has through-holes 30 that are arranged in a lengthwise direction and/or a widthwise direction at predetermined intervals (i.e., according to a predetermined pattern), and that penetrate the resin film 10 and the pressure-sensitive adhesive layer 20 integrally. The arrangement pattern of the through-holes 30 maybe appropriately set in accordance with purposes. For example, the through-holes 30 may be arranged at substantially equal intervals in each of the lengthwise direction and the widthwise direction as illustrated in FIG. 1. The phrase “substantially equal intervals in each of the lengthwise direction and the widthwise direction” means that intervals in the lengthwise direction are equal to each other and intervals in the widthwise direction are equal to each other, and it is not necessary that the intervals in the lengthwise direction and the intervals in the widthwise direction be equal to each other. For example, when the intervals in the lengthwise direction are each represented by L1, and the intervals in the widthwise direction are each represented by L2, the L1 may be equal to the L2, or the L1 may not be equal to the L2. Alternatively, the through-holes 30 may be arranged at substantially equal intervals in the lengthwise direction and arranged at different intervals in the widthwise direction, or may be arranged at different intervals in the lengthwise direction and arranged at substantially equal intervals in the widthwise direction (both cases are not shown). When the through-holes are arranged at different intervals in the lengthwise direction or the widthwise direction, all of intervals between adjacent through-holes may be different, or only part of the intervals (intervals between specific adjacent through-holes) may be different. In addition, the following may be performed: a plurality of regions are specified in the lengthwise direction of the pressure-sensitive adhesive film 100, and the intervals between the through-holes 30 in the lengthwise direction and/or the widthwise direction are set for each of the regions.

Practically, as illustrated in FIG. 2B, a long separator 22 is temporarily bonded to the pressure-sensitive adhesive layer 20 in a peelable manner to protect the pressure-sensitive adhesive layer until the layer is actually used, and to enable roll forming. In this case, as illustrated in FIG. 2B, the through-holes 30 penetrate the separator 22, the pressure-sensitive adhesive layer 20, and the resin film 10 integrally.

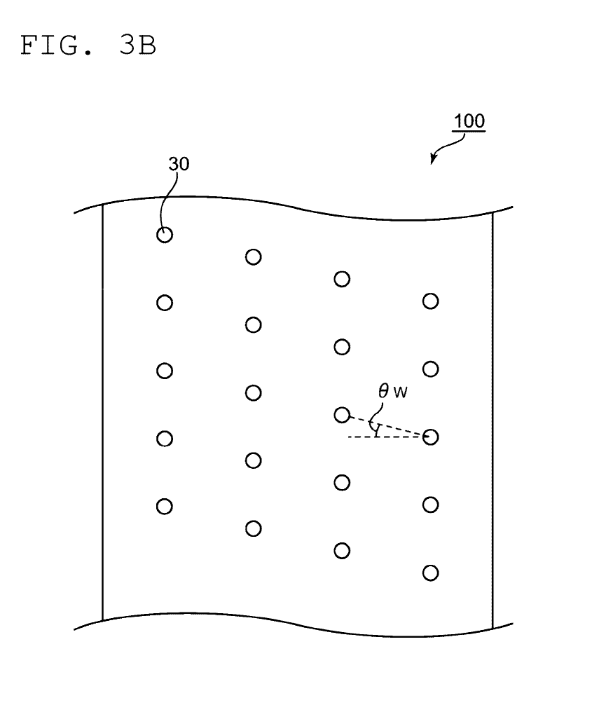

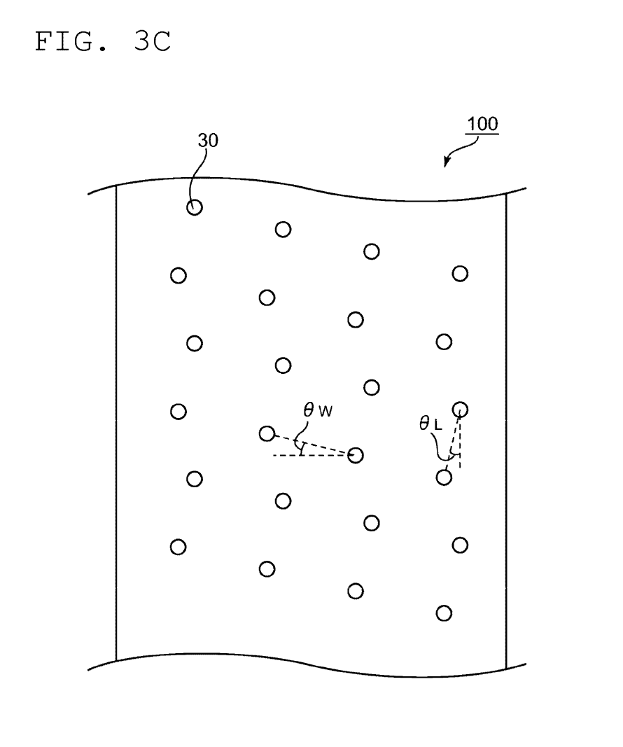

FIG. 3A is a schematic plan view for illustrating an example of the arrangement pattern of the through-holes in the pressure-sensitive adhesive film according to the embodiment of the present invention, FIG. 3B is a schematic plan view for illustrating another example of the arrangement pattern of the through-holes, and FIG. 3C is a schematic plan view for illustrating still another example of the arrangement pattern of the through-holes. In one embodiment, the through-holes 30 are arranged so that, as illustrated in FIG. 3A, a straight line connecting the through-holes adjacent, to each other in the lengthwise direction may be substantially parallel to the lengthwise direction, and a straight line connecting the through-holes adjacent to each other in the widthwise direction may be substantially parallel to the widthwise direction. This embodiment corresponds to the arrangement pattern of the through-holes in the pressure-sensitive adhesive film illustrated in FIG. 1 (FIG. 3A corresponds to the schematic plan view of FIG. 1). In another embodiment, the through-holes 30 are arranged so that, as illustrated in FIG. 3B, the straight line connecting the through-holes adjacent to each other in the lengthwise direction may be substantially parallel to the lengthwise direction, and the straight line connecting the through-holes adjacent to each other in the widthwise direction may have a predetermined angle θ_{W} with respect to the widthwise direction. In still another embodiment, the through-holes 30 are arranged so that, as illustrated in FIG. 3C, the straight line connecting the through-holes adjacent to each other in the lengthwise direction may have a predetermined angle θL with respect to the lengthwise direction, and the straight line connecting the through-holes adjacent to each other in the widthwise direction may have the predetermined angle θ_{W} with respect, to the widthwise direction. The θ_{L} and/or the θ_{W} are each/is preferably more than 0° and ±10° or less. Here, the symbol “±” means that both clockwise and counterclockwise directions with respect to a reference direction (the lengthwise direction or the widthwise direction) are included. Each of the embodiments illustrated in FIG. 3B and FIG. 3C has such advantages as follows. As described later, as one application, the pressure-sensitive adhesive film of the present invention can be used in the production of a polarizer having non-polarization portions. When the pressure-sensitive adhesive film of the present invention is used, the non-polarization portions can be formed according to a desired pattern while a long polarizer is conveyed with rolls. As a result, the non-polarization portions can be formed over the entirety of the long polarizer while their arrangement pattern is precisely controlled. Here, in some image display apparatus, the absorption axis of a polarizer may be required to be arranged while being shifted by up to about 10° with respect to the long side or short side of each of the apparatus for improving its display characteristics. The absorption axis of the polarizer is expressed in the lengthwise direction or the widthwise direction. Accordingly, when the non-polarization portions are formed by using the pressure-sensitive adhesive film of each of such patterns as illustrated in FIG. 3B and FIG. 3C, in such cases, a positional relationship between each of the non-polarization portions and the absorption axis can be controlled in the entirety of the long polarizer in a unified manner, and hence a final product excellent in axial accuracy (and hence excellent in optical characteristics) can be obtained. Therefore, the directions of the absorption axes of sheets of polarizers cut (e.g., cut in the lengthwise direction and/or the widthwise direction, or punched) out of the long polarizer can each be precisely controlled to a desired angle, and a variation in absorption axis direction between the polarizers can be significantly suppressed. Needless to say, the arrangement pattern of the through-holes is not limited to the illustrated examples. For example, the through-holes 30 may be arranged so that the straight line connecting the through-holes adjacent, to each other in the lengthwise direction may have the predetermined angle θ_{L} with respect to the lengthwise direction, and the straight line connecting the through-holes adjacent to each other in the widthwise direction may be substantially parallel to the widthwise direction. In addition, the following may be performed: a plurality of regions are specified in the lengthwise direction of the pressure-sensitive adhesive film 100, and the θ_{L} and/or the θ_{W} are/is set for each of the regions.

Any appropriate shape may be adopted as the plan-view shape of each of the through-holes 30 in accordance with purposes. Specific examples thereof include a circular shape, an elliptical shape, a square shape, a rectangular shape, and a diamond shape.

The through-holes 30 may each be formed by, for example, cutting or the removal of a predetermined portion of the pressure-sensitive adhesive film (e.g., laser ablation or chemical dissolution). A method for the cutting is, for example, a method involving mechanically cutting the pressure-sensitive adhesive film with a cutting blade (punching die), such as a Thomson blade or a pinnacle blade, or a water jet, or a method involving irradiating the pressure-sensitive adhesive film with laser light to cut the film.

The cutting with a cutting blade may be performed by any appropriate mode. For example, the cutting may be performed by using a punching apparatus in which a plurality of cutting blades are arranged according to a predetermined pattern, or may be performed by moving a cutting blade with an apparatus like an XY plotter. As described above, the cutting can be performed by moving a cutting blade so that the blade may correspond to a predetermined position of the pressure-sensitive adhesive film, and hence a through-hole can be formed at a desired position of the pressure-sensitive adhesive film with high accuracy. In one embodiment, while the long pressure-sensitive adhesive film is conveyed with rolls, the cutting with a cutting blade may be performed in appropriate conjunction with the conveyance. More specifically, a through-hole can foe formed at the desired position of the pressure-sensitive adhesive film by appropriately adjusting the timing of the cutting and/or the moving speed of a cutting blade in consideration of the conveying speed of the pressure-sensitive adhesive film. The punching apparatus may be of a reciprocating system (flattening), or may be of a rotary system (rotation).

Any appropriate laser may be adopted as a laser to be used in the cutting as long as the pressure-sensitive adhesive film can be cut. A laser that can radiate light having a wavelength in the range of from 193 nm to 10.6 μm is preferably used. Specific examples thereof include: a gas laser, such as a CO₂ laser or an excimer laser; a solid laser, such as an YAG laser; and a semiconductor laser. Of those, a CO₂ laser is preferably used. At the time of the cutting, conditions for the irradiation with the laser light may be set to any appropriate conditions in accordance with, for example, the laser to be used. When the CO₂ laser is used, its output condition is, for example, from 0.1 W to 250 W.

The laser ablation is performed by any appropriate mode. Any appropriate laser may be adopted as a laser to be used in the laser ablation. Specific examples thereof include the same lasers as those used at the time of the cutting. At the time of the laser ablation, any appropriate conditions may be adopted as conditions for irradiation with laser light (an output condition, a moving speed, and the number of times) in accordance with, for example, formation materials for the pressure-sensitive adhesive film (substantially the resin film and the pressure-sensitive adhesive layer), the thickness of the pressure-sensitive adhesive film, the plan-view shape of each of the: through-holes, and the area of each of the through-holes.

When the pressure-sensitive adhesive film is cut, one side of the pressure-sensitive adhesive film is preferably protected with a protector. Specifically, the surface of the pressure-sensitive adhesive film on a cutting direction end side is protected with the protector. When the protector is used, a perforation residue can be removed simultaneously with the peeling of the protector from the pressure-sensitive adhesive film after the cutting. Specifically, the protector can be peeled from the pressure-sensitive adhesive film under a state in which the perforation residue adheres to the protector. As a result, productivity can be markedly improved. In addition, the use of the protector can suppress the deformation of the pressure-sensitive adhesive film due to the cutting. For example, when the cutting is performed with a cutting blade, the deformation of, in particular, the pressure-sensitive adhesive layer can be suppressed.

In a preferred embodiment, the through-holes are each formed by making a notch from the surface of the pressure-sensitive adhesive film to the midst of the protector. According to such embodiment, through-holes that penetrate the resin film and the pressure-sensitive adhesive layer (and, if present, the separator) integrally can foe satisfactorily formed. In addition, the perforation residue can be satisfactorily removed at the time of the peeling of the protector from the pressure-sensitive adhesive film.

A polymer film is preferably used as the protector. The same film as the resin film may be used as the polymer film. Further, a soft (e.g., low-modulus of elasticity) film like a polyolefin (e.g., polyethylene) film may also be used. In one embodiment, a film having a high hardness (e.g., a high modulus of elasticity) is preferably used as the polymer film. This is because the deformation of the pressure-sensitive adhesive film due to the cutting can be satisfactorily suppressed. The thickness of the polymer film is preferably front 20 μm to 100 μm.

The protector is preferably bonded to the pressure-sensitive adhesive film through intermediation of a pressure-sensitive adhesive. The bonding of the protector to the pressure-sensitive adhesive film can prevent an inconvenience, such as the shift of the protector at the time of the cutting. In addition, the bonding enables satisfactory removal of the perforation residue at the time of the peeling of the protector from the pressure-sensitive adhesive film. Any appropriate pressure-sensitive adhesive may be used as the pressure-sensitive adhesive for bonding the protector as long as the pressure-sensitive adhesive has such a pressure-sensitive adhesive strength that the protector can he peeled from the pressure-sensitive adhesive film after the cutting. In one embodiment, a pressure-sensitive adhesive layer is formed in advance on the protector. The thickness of the pressure-sensitive adhesive layer formed on the protector is preferably from 1 μm to 50 μm.

In one embodiment, the shape of the protector is preferably caused to correspond to the shape of the pressure-sensitive adhesive film. For example, a long protector is used for a long pressure-sensitive adhesive film. According to such form, the perforation residue can be satisfactorily removed at the time of the peeling of the protector from the pressure-sensitive adhesive film. In addition, the perforation residue can be continuously removed and hence productivity can be markedly improved.

At the time of the formation of the through-holes, the pressure-sensitive adhesive film is preferably cut from its separator side. When the pressure-sensitive adhesive film is cut from the separator side, an influence on the bonding of a pressure-sensitive adhesive film obtained by the cutting can be suppressed. Specifically, when the cutting is performed with a cutting blade, the pressure-sensitive adhesive layer of the pressure-sensitive adhesive film may deform following the cutting blade. When the cutting is performed from the resin film side, there is a risk in that the pressure-sensitive adhesive layer swells to the pressure-sensitive adhesive surface side of the pressure-sensitive adhesive film to be obtained, and hence a swelling portion is formed on the peripheral edge of a through-hole. As a result, when the pressure-sensitive adhesive film to be obtained is bonded to an adherend, air bubbles may occur around the through-hole. Meanwhile, when the cutting is performed from the separator side, the pressure-sensitive adhesive layer may deform following the cutting blade. However, the peripheral edge of a through-hole of the pressure-sensitive adhesive film to be obtained on the pressure-sensitive adhesive surface side is in a smooth state (e.g., an arcuate surface), and hence the occurrence of the air bubbles can be prevented even when the film is bonded to the adherend. In addition, when the cutting is performed from the separator side, in the case where the protector is used, the perforation residue can be satisfactorily removed at the time of the peeling of the protector from the pressure-sensitive adhesive film after the cutting. For example, the following inconvenience can be prevented: only part of the perforation residue (typically a separator portion) is removed.

### A-2. Resin Film

The resin film 10 can function as the base material of the pressure-sensitive adhesive film 100. The resin film is preferably a film having a high hardness (e.g., a high modulus of elasticity). This is because the deformation of the through-holes at the time of the conveyance and/or bonding of the pressure-sensitive adhesive film can be prevented. Examples of formation materials for the resin film include: an ester-based resin, such as a polyethylene terephthalate-based resin; a cycloolefin-based resin, such as a norbornene-based resin; an olefin-based resin, such as polypropylene; a polyamide-based resin; a polycarbonate-based resin; and copolymer resins thereof. Of those, an ester-based resin (especially a polyethylene terephthalate-based resin) is preferred. Such material has an advantage in that its modulus of elasticity is sufficiently high, and hence the deformation of the through-holes hardly occurs even when a tension is applied at the time of the conveyance and/or the bonding.

The thickness of the resin film is typically from 20 μm to 250 μm, preferably from 30 μm to 150 μm. Such thickness has an advantage in that the deformation of the through-holes hardly occurs even when a tension is applied at the time of the conveyance and/or the bonding.

The modulus of elasticity of the res in film is preferably from 2.2 kN/mm² to 4.8 kN/mm². When the modulus of elasticity of the resin film falls within such range, the following advantage, is obtained: the deformation of the through-holes hardly occurs even when a tension is applied at the time of the conveyance and/or the bonding. The modulus of elasticity is measured in conformity with JIS K 6781.

The tensile elongation of the resin film is preferably from 90% to 170%. When the tensile elongation of the resin film falls within such range, the following advantage is obtained: the film is hardly ruptured during the conveyance. The tensile elongation is measured in conformity with JIS K 6781.

A-3. Pressure-Sensitive Adhesive Layer

Any appropriate pressure-sensitive adhesive may be adopted as a pressure-sensitive adhesive forming the pressure-sensitive adhesive layer. The base resin of the pressure-sensitive adhesive is, for example, an acrylic resin, a styrene-based resin, or a silicone-based resin. Of those, an acrylic resin is preferred from the viewpoints of, for example, chemical resistance, adhesiveness for preventing the penetration of a treatment liquid at the time of immersion, and a degree of freedom to an adherend. A cross-linking agent, that, may be incorporated into the pressure-sensitive adhesive is, for example, an isocyanate compound, an epoxy compound, or an aziridine compound. The pressure-sensitive adhesive may contain, for example, a silane coupling agent. The compounding formulation or the pressure-sensitive adhesive may he appropriately set in accordance with purposes.

The thickness of the pressure-sensitive adhesive layer is preferably from 1 μm to 60 μm, more preferably from 3 μm to 30 μm. When the thickness is excessively small, the pressure-sensitive adhesive property of the layer becomes insufficient, and hence, for example, air bubbles enter a pressure-sensitive adhesive interface between the resin film and the layer in some cases. When the thickness is excessively large, an inconvenience, such as the protrusion of the pressure-sensitive adhesive, is liable to occur.

A-4. Separator

The separator 22 has a function as a protective material for protecting the pressure-sensitive adhesive film (pressure-sensitive adhesive layer) until the film is subjected to practical use. In addition, when the separator is used, the pressure-sensitive adhesive film can be satisfactorily wound in a roll shape. The separator is, for example, a plastic (e.g., polyethylene terephthalate (PET), polyethylene, or polypropylene) film, nonwoven fabric, or paper having a surface coated with a releasing agent, such as a silicone-based releasing agent, a fluorine-based releasing agent, or a long-chain alkyl acrylate-based releasing agent. Any appropriate thickness may be adopted as the thickness of the separator in accordance with purposes. The thickness of the separator is, for example, from 10 μm to 100 μm.

B. Applications of Pressure-Sensitive Adhesive Film

The pressure-sensitive adhesive film of the present invention can be suitably used as, for example, a surface protective film or mask at the time of a selective treatment of a predetermined portion of a film (typically a long film). Specific examples of the selective treatment include decoloring, coloring, perforation, development, etching, patterning (e.g., the formation of an active energy ray-curable resin layer), chemical modification, and a heat treatment. When the pressure-sensitive adhesive film of the present invention is used, a continuous treatment can be performed while the long film is conveyed with rolls, and hence the treatment efficiency of each of various selective treatments can be extremely improved. Further, when the pressure-sensitive adhesive film of the present invention is used, portions to be selectively treated can be arranged over the entirety of the long film under precise control. Accordingly, when final products each having a predetermined size are cut out of the long film, a variation in quality between the final products can be significantly suppressed. In one embodiment, the pressure-sensitive adhesive film of the present invention can be used in the production of a polarizer (typically a long polarizer) having non-polarization portions. When the pressure-sensitive adhesive film of the present invention is used in the application, low-cost, high-yield, and high-productivity production of the polarizer suitable for the multi-functionalization and high-functionalization of an electronic, device, such as an image display apparatus, can be achieved. The production of the polarizer having the non-polarization portions is specifically described below as a typical example of the selective treatment.

C. Production of Polarizer Having Non-polarization Portions

### C-1. Polarizer

Any appropriate polarizer may be adopted as the polarizer in which the non-polarization portions may be formed. The polarizer typically includes a resin film. The resin film is typically a polyvinyl alcohol-based resin (hereinafter referred to as “PVA-based resin”) film containing a dichromatic substance. The polarizer may be a single film, or may be a resin layer (typically a PVA-based resin layer) formed on a resin substrate. A laminate of the resin substrate and the resin layer may be obtained by, for example, a method involving applying an application liquid containing a formation material for the resin film to the resin substrate, or a method involving laminating the resin film on the resin substrate.

Examples of the dichromatic substance include iodine and an organic dye. The substances may be used a lone or in combination. Of those, iodine is preferably used. This is because of the following reason: for example, when non-polarization portions are formed by decoloring based on a chemical treatment using the pressure-sensitive adhesive film of the present invention an iodine complex in the resin film (polarizer) is appropriately reduced, and hence non-polarization portions each having appropriate characteristics can be formed.

Any appropriate resin may be used as the PVA-based resin, Examples of the PVA-based resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically from 85 mol % to 100 mol %, preferably from 95.0 mol % to 99.95 mol %, more preferably from 99.0 mol % to 99.93 mol %. The saponification degree may be determined in conformity with JIS K 6726-1994. The use of the PVA-based resin having such saponification degree can provide a polarizer excellent in durability. When the saponification degree is excessively high, the resin may gel.

The average polymerization degree of the PVA-based resin may be appropriately selected in accordance with purposes. The average polymerization degree is typically from 1,000 to 10,000, preferably from 1,200 to 4,500, more preferably from 1,500 to 4,300. The average polymerization degree may be determined in conformity with JIS K 6726-1994.

The polarizer preferably shows absorption dichroism at any wavelength in the wavelength range of from 380 nm to 780 nm. The single axis transmittance (Ts) of the polarizer (except the non-polarization portions) is preferably 39% or more, more preferably 39.5% or more, still more preferably 40% or more, particularly preferably 40.5% or more. A theoretical upper limit for the single axis transmittance is 50%, and a practical upper limit, therefor is 46%. In addition, the single axis transmittance (Ts) is a Y value measured with the two-degree field of view (C light, source) of JIS Z 8701 and subjected to visibility correction, and may be measured with, for example, a microspectroscopic system (manufactured by Lambda Vision Inc., LVmicro). The polarization degree of the polarizer (except the non-polarization portions) is preferably 99.9% or more, more preferably 99.93% or more, still more preferably 99.95% or more.

The thickness of the polarizer may be set to any appropriate value. The thickness is preferably 30 μm or less, more preferably 25 μm or less, still more preferably 20 μm or less, particularly preferably 10 μm or less. Meanwhile, the thickness is preferably 0.5 μm or more, more preferably 1 μm or more. With such thickness, a polarizer having excellent, durability and excellent optical characteristics can be obtained. As the thickness becomes smaller, the non-polarization portions can be formed more satisfactorily. For example, when the non-polarization portions are formed by decoloring based, on a chemical, treatment, the time period for which a treatment liquid, (a decoloring solution) and the resin film (polarizer) are brought into contact with each other can be shortened.

The absorption axis of the polarizer may be set to any appropriate direction in accordance with purposes. The direction of the absorption axis may be, for example, the lengthwise direction or the widthwise direction. A polarizer having an absorption axis in its lengthwise direction has an advantage in that the polarizer is excellent, in production efficiency. A polarizer having an absorption axis in its widthwise direction has an advantage in that the polarizer can foe laminated together with, for example, a retardation film having a slow axis in its lengthwise direction by a so-called roll-to-roll process.

The polarizer may be produced by any appropriate method. When the polarizer is the single PVA-based resin film, the polarizer may be produced by a method well-known and commonly used in the art. When the polarizer is the PVA-based resin layer formed on the resin substrate, the polarizer may be produced by a method described in, for example, JP 2012-73580 A. The entire description of the literature is incorporated herein by reference.

The polarizer is subjected to the formation of the non-polarization portions to be described later in any appropriate form, Specifically, the polarizer to be subjected to the formation of the non-polarization portions may be a single PVA-based resin film, may be a laminate of a resin substrate and a PVA-based resin layer, or may be a laminate obtained by arranging a protective film on one side, or each of both sides, of a PVA-based resin film or a PVA-based resin layer (i.e., a polarizing plate). The polarizing plate to foe subjected to the formation of the non-polarization portions may include a pressure-sensitive adhesive layer so as to be capable of being bonded to an image display apparatus. In addition, the polarizing plate may further include any appropriate optical functional layer in accordance with purposes. Typical examples of the optical functional layer include a retardation film (optical compensation film) and a surface-treated layer. The case where the non-polarization portions are formed in the polarizer of a polarizing plate having a construction “polarizer/protective film” is described below as an example.

C-2. Formation of Non-polarization Portions

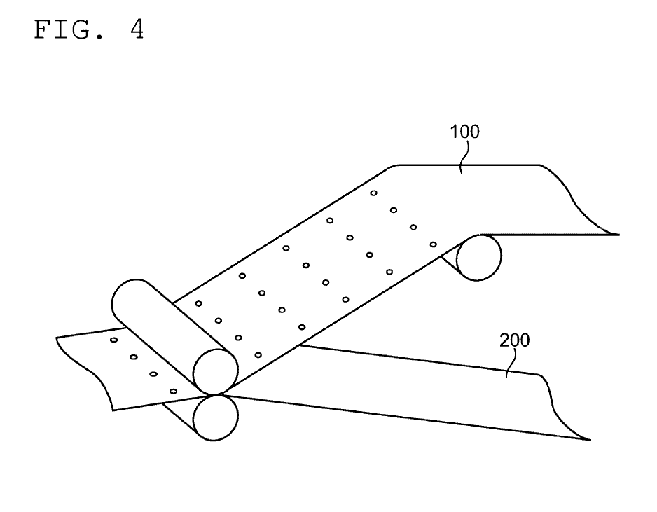

As illustrated in FIG. 4, the pressure-sensitive adhesive film 100 is bonded to a surface of a polarizing plate 200 on the polarizer side by a roll-to-roll process. The pressure-sensitive adhesive film 100 is the pressure-sensitive adhesive film of the present invention described in the section A. In the illustrated example, the arrangement pattern of the through-holes in the pressure-sensitive adhesive film corresponds to the arrangement pattern of each of FIG. 1 and FIG. 3A. The term “roll-to-roll process” as used herein means that roll-shaped films are laminated with their lengthwise directions aligned with each other while being conveyed. The pressure-sensitive adhesive film is typically bonded to the polarizer in a peelable manner. When the pressure-sensitive adhesive film of the present invention is used, non-polarization portions can be formed by a decoloring treatment based on immersion in a decoloring liquid, and hence a polarizer having non-polarization portions can be obtained with extremely high production efficiency. The pressure-sensitive adhesive film of the present invention may be referred to as “first surface protective film” for convenience because the pressure-sensitive adhesive film of the present invention can function as a surf ace protective film for the polarizing plate in the decoloring treatment. Here, the surface protective film refers to a film that temporarily protects the polarizing plate at the time of an operation and that is peeled at any appropriate time point, and the film is different from a polarizer protective film simply referred to as “protective film.”

When the polarizer and the pressure-sensitive adhesive film are laminated by the roll-to-roll process, the following may be performed: the long pressure-sensitive adhesive film is unwound from a pressure-sensitive adhesive film roll in which, the pressure-sensitive adhesive film has been wound in a roll shape, and is laminated on the polarizer. The following may also be performed: after the through-holes have been formed in the pressure-sensitive adhesive film, the pressure-sensitive adhesive film is continuously laminated on the polarizer (without winding the pressure-sensitive adhesive film).

Meanwhile, a surface protective film (second surface protective film) is bonded to a surface of the polarizing plate on the protective film side by the roll-to-roll process (not shown). The second surface protective film is bonded to the polarizer protective film through intermediation of any appropriate pressure-sensitive adhesive in a peelable manner. The use of the second surface protective film enables appropriate protection of the polarizing plate (polarizer/protective film) in the decoloring treatment based on immersion. The same film as the pressure-sensitive adhesive film (first, surface protective film) of the present invention except that no through-holes are arranged may be used as the second surface protective film. Further, a soft (e.g., low-modulus of elasticity) film like a polyolefin (e.g., polyethylene) film may also be used as the second surface protective film. The second surface protective film may be bonded simultaneously with the first surface protective film, may be bonded before the bonding of the first surface protective film, or may be bonded after the bonding of the first surface protective film. The second surface protective film is preferably bonded before the bonding of the first surface protective film. Such procedure has the following advantages: the protective film is prevented from being flawed; and the through-holes in the pressure-sensitive adhesive film are prevented from being transferred as traces onto the protective film at the time of its winding. The mode in which the second surface protective film is bonded before the bonding of the first surface protective film is suitably applicable to, for example, the case where the polarizer is a PVA-based resin layer-formed on a resin substrate. Specifically, the following may be performed. A laminate of the polarizer protective film and the second surface protective film is produced, and the laminate is bonded to the laminate of the resin substrate and the polarizer. After that, the resin substrate is peeled and the first surface protective film is bonded to the surface from which the resin substrate has been peeled.

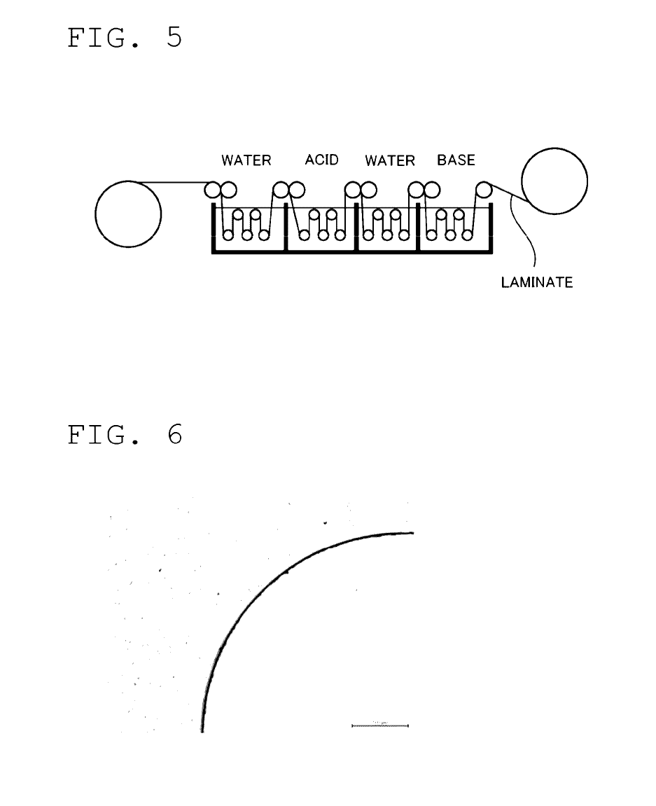

Next, as illustrated in FIG. 5, the laminate of the pressure-sensitive adhesive film (first surface protective film) of the present invention/polarizer/protective film/second surface protective film is subjected to the chemical decoloring treatment. The chemical decoloring treatment typically involves bringing the laminate into contact, with a decoloring solution (for example, a basic solution). The chemical decoloring treatment may further include, as required, removing the basic solution, bringing the laminate into contact with an acidic solution, and removing the acidic solution. The treatment is specifically described below.

The contact between the laminate and the basic solution maybe performed by any appropriate means. Typical examples thereof include: the immersion of the laminate in the basic solution; and the application or spraying of the basic solution onto the laminate. Of those, immersion is preferred. This is because of the following reason: the decoloring treatment can be performed while the laminate is conveyed as illustrated in FIG. 5, and hence production efficiency is significantly high. As described above, the use of the first surface protective film (and, as required, the second surface protective film) enables the immersion. Specifically, when the laminate is immersed in the basic solution, only portions in the polarizer corresponding to the through-holes of the pressure-sensitive adhesive film of the present invention (the first-surface protective film) are brought into contact with the basic solution. For example, in the case where the polarizer contains iodine as a dichromatic substance, when the polarizer and the basic solution are brought into contact with each other, the iodine concentrations of the contact portions of the polarizer with the basic solution are reduced. As a result, the non-polarization portions can be selectively formed only in the contact portions (that can be set by the through-holes of the pressure-sensitive adhesive film of the present invention). As described above, according to this embodiment, the non-polarization portions can be selectively formed in the predetermined, portions of the polarizer with extremely high production efficiency without any complicated operation. In the case where iodine remains in the polarizer, even when the non-polarization portions are formed by breaking an iodine complex, there is a risk in that the iodine complex is formed again in association with the use of the polarizer, and hence the non-polarization portions do not have desired characteristics. In this embodiment, iodine itself is removed from the polarizer (substantially the non-polarization portions) by the removal of the basic solution to be described later. As a result, changes in characteristics of the non-polarization portions in association with the use of the polarizer can be prevented.

The formation of the non-polarization portions with the basic solution is described in more detail. After having been brought into contact with a predetermined portion of the polarizer, the basic solution permeates into the predetermined portion. The iodine complex in the predetermined portion is reduced by a base in the basic solution to become an iodine ion. The reduction of the iodine complex to the iodine ion substantially eliminates the polarization performance of the portion and hence leads to the formation of a non-polarization portion in the portion. In addition, the reduction of the iodine complex increases the transmittance of the portion. Iodine that has become the iodine ion moves from the portion into the solvent of the basic solution. As a result, through the removal of the basic solution to be described later, the iodine ion is also removed from the portion together with the basic solution. Thus, a non-polarization portion is selectively formed in the predetermined portion of the polarizer, and the non-polarization portion is a stable portion that does not change with time. The permeation of the basic solution into even an undesired portion (and as a result, the formation of a non-polarization portion in the undesired portion) can foe prevented by adjusting, for example, the material, thickness, and mechanical characteristics of the pressure-sensitive adhesive film of the present invention (more specifically, the resin film and the pressure-sensitive adhesive layer), the concentration of the basic solution, and the time period for which the laminate is immersed in the basic solution.

Any appropriate basic compound may be used as a basic compound in the basic solution. Examples of the basic compound include: hydroxides of alkali metals, such as sodium hydroxide, potassium hydroxide, and lithium hydroxide; hydroxides of alkaline earth metals, such as calcium hydroxide; inorganic alkali metal salts, such as sodium carbonate; organic alkali metal salts, such as sodium acetate; and ammonia water. The basic compound in the basic solution is preferably hydroxides of alkali metals, and more preferably sodium hydroxide, potassium hydroxide, and lithium hydroxide. The use of the basic solution containing hydroxides of alkali metals can efficiently ionize the iodine complex, and hence can form the non-polarization portion with additional ease. Those basic compounds may be used alone, or in combination.

Any appropriate solvent may be used as the solvent of the basic solution. Specific examples thereof include: water; alcohols, such as ethanol and methanol; ethers; benzene; chloroform; and mixed solvents thereof. The solvent is preferably water or an alcohol because an iodine ion satisfactorily migrates to the solvent and hence the iodine ion can be easily removed in the subsequent removal of the basic solution.

The concentration of the basic solution is, for example, from 0.01 N to 5 N, preferably from 0.05 N to 3 N, more preferably from 1 N to 2.5 N. When the concentration, of the basic solution falls within such range, an iodine concentration in the polarizer can be efficiently reduced, and the ionization of the iodine complex in a portion except a predetermined portion can be prevented.

The liquid temperature of the basic solution is, for example, from 20° C. to 50° C. The time period for which the laminate (substantially the predetermined portions of the polarizer) and the basic solution are brought into contact with each other may be set in accordance with the thickness of the polarizer, the kind of the basic compound in the basic solution to be used, and the concentration of the basic compound, and is, for example, from 5 seconds to 30 minutes.

After having been brought into contact with the predetermined portions of the polarizer, the basic solution may be removed by any appropriate means as required. A method of removing the basic solution is specifically, for example, washing, removal by wiping with a waste cloth or the like, removal by suction, natural drying, heat drying, air-blow drying, or drying under reduced pressure. Of those, washing is preferred. This is because the washing is excellent in performance by which the basic solution is removed, eliminates the need for a complicated apparatus, and is excellent in production efficiency. A liquid to be used in the washing is, for example, water (pure water), an alcohol, such as methanol or ethanol, an acidic aqueous solution, or a mixed solvent, thereof. Of those, water is preferred. The washing is typically performed while the laminate is conveyed as illustrated in FIG. 5. The washing may be performed a plurality of times. A drying temperature when the basic solution is removed by drying is, for example, from 20° C. to 100° C.

The laminate (substantially the predetermined portions of the polarizer) that has been brought into contact with the basic solution may be further brought into contact with an acidic solution as required. The contact between the laminate and the acidic solution may be performed by any appropriate means. Immersion is preferred as in the case of the contact with the basic solution. When the laminate is brought into contact with the acidic solution, the basic solution remaining in the non-polarization portions can be removed at a more satisfactory level. In addition, when the laminate is brought into contact with the acidic solution, the dimensional stability and durability of each of the non-polarization portions can be improved. The contact with the acidic solution may be performed after the performance of the removal of the basic solution, or may be performed without the removal of the basic solution.

Any appropriate acidic compound may be used as an acidic compound in the acidic solution. Examples of the acidic compound include: inorganic acids, such as hydrochloric acid, sulfuric acid, nitric acid, and hydrogen fluoride; and organic acids, such as formic acid, oxalic acid, citric acid, acetic acid, and benzoic acid. Of those, an inorganic acid is preferred as the acidic compound in the acidic solution, and hydrochloric acid, sulfuric acid, or nitric acid is more preferred. Those acidic compounds may be used alone or in combination.

The solvents given as the examples of the solvent of the basic solution may each be used as the solvent of the acidic solution. The concentration of the acidic solution is, for example, from 0.01 N to 5 N, preferably from 0.05 N to 3 N, more preferably from 0.1 M to 2.5 M.

The liquid temperature of the acidic solution is, for example, from 20° C. to 50° C. The time period for which the laminate (substantially the predetermined portions of the polarizer) and the acidic solution are brought into contact with each other may be set in accordance with the thickness of the resin film (polarizer), the kind of the acidic compound in the acidic solution to be used, and the concentration of the acidic compound, and is, for example, from 5 seconds to 30 minutes. Immediately after the laminate and the acidic solution have been brought into contact with each other, the solution may be removed by wiping or the like as required.

After having been brought into contact with the predetermined portions of the polarizer, the acidic solution may be removed by any appropriate means as required. Washing is preferred as in the case of the removal of the basic solution. Examples of a solution to be used in the washing include water (pure water), an alcohol, such as methanol or ethanol, an acidic aqueous solution, and a mixed solvent thereof. Of those, water is preferred. The washing is typically performed while the laminate is conveyed as illustrated in FIG. 5. The washing may be performed a plurality of times.

When the acidic solution is removed by the washing in this embodiment, the laminate after the removal of the acidic solution is subjected, to the removal of the washing liquid and drying as required (not shown). The removal of the washing liquid (typically water) may be performed by any appropriate means. Specific examples thereof include blowing-off with a blower, the passage of the laminate through a sponge roll, and a combination thereof. The removal of the washing liquid enables a more satisfactory level of removal of the washing liquid remaining in the through-hole portions of the first surface protective film, and hence can prevent the remaining washing liquid from adversely affecting the polarizer. The drying may be performed by, for example, conveying the laminate in an oven. A drying temperature is, for example, from 20° C. to 100° C., and a drying time is, for example, from 5 seconds to 600 seconds.

After the non-polarization portions have been formed as described above, the pressure-sensitive adhesive film (first surface protective film) of the present invention and the second surface protective film may be typically peeled and removed.

When the arrangement pattern of the through-holes of the pressure-sensitive adhesive film of the present invention is set as described above, the non-polarization portions can be formed at the predetermined positions of the long polarizer according to a predetermined arrangement pattern. The polarizer having the non-polarization portions can be used in, for example, an image, display apparatus having a camera portion.

When the polarizer is cut into a predetermined size to be mounted on an image display apparatus having a predetermined size, the non-polarization portions are each typically arranged at a position corresponding to a camera portion of the image display apparatus. Therefore, when polarizers having only one size are cut out of the one long polarizer, the non-polarization portions may be arranged at substantially equal intervals in each of the lengthwise direction and widthwise direction of the long polarizer as illustrated in FIG. 1. According to such construction, the cutting of the polarizer into the predetermined size in accordance with the size of the image display apparatus is easily controlled, and hence a yield can be improved. Further, the positions of the non-polarization portions can be accurately set, and hence the positions of the non-polarization portions in polarizers each having the predetermined size to be obtained can also be satisfactorily controlled. As a result, a variation in position of a non-polarization portion between the polarizers each having the predetermined size to be obtained is reduced, and hence the polarizers each having the predetermined size, the polarizers being free of any variation in quality, can be obtained. When polarizers having a plurality of sizes are cut out of the one long polarizer, the intervals between the non-polarization portions in the lengthwise direction and/or the widthwise direction may be changed in accordance with the sizes of the polarizers to toe cut out of the long polarizer. When the arrangement pattern of the through-holes in the pressure-sensitive adhesive film of the present invention is appropriately set as described above, the non-polarization portions can be formed according to a desired arrangement pattern.

The transmittance of each of the non-polarization portions (e.g., a transmittance measured with light having a wavelength of 550 nm at 23° C.) is preferably 50% or more, more preferably 60% or more, still more preferably 75% or more, particularly preferably 90% or more. With such transmittance, desired transparency as a non-polarization portion can be secured. As a result, when the polarizer is arranged so that the non-polarization portions may each correspond to the camera portion of an image display apparatus, an adverse effect on the photographing performance of its camera can be prevented.

The content of the dichromatic substance in each of the non-polarization portions is preferably 1.0 wt % or less, more preferably 0.5 wt % or less, still more preferably 0.2 wt % or less. When the content of the dichromatic substance in each of the non-polarization portions falls within such range, the transmittance can be sufficiently satisfied.

Any appropriate shape may be adopted as the plan-view shape of each of the non-polarization portions as long as the shape does not adversely affect the camera performance of an image display apparatus in which the polarizer is used. When the shape of each of the through-holes in the pressure-sensitive adhesive film of the present invention is appropriately set, non-polarization portions each having a desired plan-view shape can be formed.

The formation of the non-polarization portions in the long polarizer has heretofore been described as an example of the selective treatment of a predetermined portion of a long film with the pressure-sensitive adhesive film of the present invention. However, it is apparent to a person skilled in the art that the pressure-sensitive adhesive film of the present invention is applicable also to such other selective treatment as described above by a similar procedure.

### EXAMPLES

### Example 1

A long laminate (width: 1,200 mm, length: 43 m) having a construction “ester-based film (thickness: 38 μm)/pressure-sensitive adhesive layer (thickness: 5 μm)/separator (thickness: 25 μm)” was prepared. A carrier film (width: 1,200 mm, length: 43 m) having a construction “ester-based film (thickness: 38 μm)/pressure-sensitive adhesive layer (thickness: 5 μm)” was bonded to the ester-based film surface of the laminate by a roll-to-roll process. Thus, a laminate with a carrier film was produced.

Next, a cutting blade having a depth of 80 μm was inserted into the laminate with the carrier film from its separator surface by using a punching apparatus to perform the following half cutting: the laminate was perforated with circles each having a diameter of 2.4 mm so that the circles did not penetrate the carrier film. The half cutting was performed every 250 mm in a lengthwise direction and every 400 mm in a widthwise direction.

Subsequently, the carrier film was peeled from the laminate. Thus, a pressure-sensitive adhesive film was obtained.

### Example 2

A pressure-sensitive adhesive film was obtained in the same manner as in Example 1 except that half cutting (cutting depth: 80 μm) was performed with a laser cutting machine (CO₂ laser, wavelength: 9.4 μm, output: 10 W) instead of the punching apparatus.

Examples were each, subjected to the following evaluations.

1. Perforation Residue

Whether or not a perforation residue due to cutting was removed at the time of the peeling of a carrier film was observed.

### 2. Bonding Appearance of Pressure-Sensitive Adhesive Film

A separator was peeled and a pressure-sensitive adhesive film was bonded to a commercially available polarizer, followed by the observation of the appearance of the film with a microscope.

In each of Examples, the perforation residue caused by the half cutting was completely removed at the time of the peeling of the carrier film.

Each of the resultant pressure-sensitive adhesive films was bonded to a polarizer, and the state of bonding between the polarizer and the pressure-sensitive adhesive film was observed. As a result, as shown in FIG. 6, no inclusion of air bubbles was observed between the polarizer and the pressure-sensitive adhesive film.

TABLE 1

| | | Cutting | Bonding |
|---|---|---|---|
| | Cutting method | direction | appearance |
| Example 1 | Punching | Separator side | No inclusion of |
| | apparatus | | air bubbles |
| Example 2 | Irradiation with | Separator side | No inclusion of |
| | laser light | | air bubbles |

[Production of Polarizing Plate]

An amorphous isophthalic acid-copolymerized polyethylene terephthalate (IPA-copolymerized PET) film of along shape (thickness: 100 μm) having a water absorption ratio of 0.75% and a Tg of 75° C. was used as a substrate. One surface of the substrate was subjected to a corona treatment, and an aqueous solution containing polyvinyl alcohol (polymerization degree: 4,200, saponification degree: 99.2 mol %) and acetoacetyl-modified PVA (polymerization degree: 1,200, acetoacetyl modification degree: 4.6%, saponification degree: 99.0 mol % or more, manufactured by The Nippon Synthetic Chemical Industry Co., Ltd., trade name: “GOHSEFIMER Z-200”) at a ratio of 9:1 was applied to the corona-treated surface and dried at 25° C. to form a PVA-based resin layer having a thickness of 11 μm. Thus, a laminate was produced.

The resultant laminate was subjected to free-end uniaxial stretching in an oven at 120° C. between rolls having different peripheral speeds in a longitudinal direction (lengthwise direction) at 2.0 times (in-air auxiliary stretching).

Next, the laminate was immersed in an insolubilizing bath having a liquid temperature of 30° C. (an aqueous solution of boric acid obtained by compounding 100 parts by weight of water with 4 parts by weight of boric acid) for 30 seconds (insolubilizing treatment).

Next, the laminate was immersed in a dyeing bath having a liquid temperature of 30° C. while an iodine concentration and an immersion time were adjusted so that a polarising plate to be obtained had a predetermined transmittance. In this example, the laminate was immersed in an aqueous solution of iodine, which was obtained by compounding 100 parts by weight of water with 0.2 part by weight of iodine and 1.5 parts by weight of potassium iodide, for 60 seconds (dyeing treatment).

Next, the laminate was immersed in a cross-linking bath having a liquid temperature of 30° C. (an aqueous solution of boric acid obtained by compounding 100 parts by weight of water with 3 parts by weight of potassium iodide and 3 parts by weight of boric acid) for 30 seconds (cross-linking treatment).

After that, the laminate was subjected to uniaxial stretching between rolls having different, peripheral speeds in a longitudinal direction (lengthwise direction) so that a total stretching ratio became 5.5 times while being immersed in an aqueous solution of boric acid having a liquid temperature of 70° C. (an aqueous solution obtained by compounding 100 parts by weight of water with 4 parts by weight of boric acid and 5 parts by weight of potassium iodide) (underwater stretching).

After that, the laminate was immersed in a washing bath having a liquid temperature of 30° C. (an aqueous solution obtained by compounding 100 parts by weight of water with 4 parts by weight of potassium, iodide) (washing treatment).

Subsequently, a PVA-based resin aqueous solution (manufactured by The Nippon Synthetic Chemical Industry Co., Ltd., trade name: “GOHSEFIMER (trademark) Z-200”, resin concentration: 3 wt %) was applied to the PVA-based resin layer surf ace of the laminate, and a protective film (thickness: 25 μm) was bonded thereto, followed by the heating of the resultant in an oven maintained at 60° C. for 5 minutes. After that, the substrate was peeled from the PVA-based resin layer. Thus, a long polarizing plate having a width of 1,200 mm and a length of 43 m (polarizer having a thickness of 5 μm (single axis transmittance: 42.3%)/protective film) was obtained.

[Formation of Transparent Portions]

The pressure-sensitive adhesive film obtained in each of Examples was bonded to the polarizer side of the resultant polarizing plate by a roll-to-roll process after the separator had been peeled. Thus, a polarizing film laminate was obtained.

An aqueous solution of sodium hydroxide (1.0 mol/L (1.0 N)) at normal temperature was -dropped to portions where the polarizer was exposed from the pressure-sensitive adhesive film of the resultant polarizing film laminate, and the laminate was left to stand for 60 seconds. After that, the dropped aqueous solution of sodium hydroxide was removed with a waste cloth, and then the pressure-sensitive adhesive film was peeled. Thus, a polarizing plate (polarizer) having formed therein transparent portions was obtained.

The transparent portions formed by using the pressure-sensitive adhesive film of each of Examples were each evaluated for the following items.

### 1. Transmittance (Ts)

Measurement was performed with a spectrophotometer (manufactured by Murakami Color Research Laboratory, product name: “DOT-3”). A transmittance (T) is a Y value subjected to visibility correction with the two-degree field of view (C light source) of JIS Z 8701-1982.

### 2 . Iodine Content

An iodine content in each of the transparent portions of a polarizer was determined by X-ray fluorescence analysis. Specifically, the iodine content of the polarizer was determined from a calibration curve produced in advance from an X-ray intensity measured under the following conditions through the use of a standard sample.
Analysis apparatus: manufactured, by Rigaku Corporation, X-ray fluorescence (XRF) analysis: apparatus, product name “ZSX100e”
Anticathode: rhodium
Dispersive crystal: lithium fluoride
Excitation light energy: 40 kV-90 mA
Iodine measured line: I-LA
Quantification method: FP method
2θ angle peak: 103.078 deg (iodine)
Measurement time: 40 seconds

In each case, transparent portions each having a transmittance of from 93% to 94% and an iodine content of 0.15 wt % or less are formed, and the portions can function as non-polarization portions. In addition, the non-polarization portions were circles each having a diameter of 2.4 mm in correspondence with the shapes of the through-holes of the pressure-sensitive adhesive film.

### INDUSTRIAL APPLICABILITY

The pressure-sensitive adhesive film of the present invention can be suitably used as a surface protective film or mask at the time of a selective treatment of a predetermined portion of a film (typically a long film).

### REFERENCE SIGNS LIST

10 resin film
20 pressure-sensitive adhesive layer
30 through-hole
100 pressure-sensitive adhesive film
200 polarizing plate.

1. A pressure-sensitive adhesive film, comprising;
a long resin film; and
a pressure-sensitive adhesive layer arranged on one surface of the resin film,
the pressure-sensitive adhesive film having through-holes that are arranged in a lengthwise direction and/or a widthwise direction at predetermined intervals, and that penetrate the resin film and the pressure-sensitive adhesive layer integrally.

2. The pressure-sensitive adhesive film according to claim 1, wherein the through-holes are arranged in the lengthwise direction at predetermined intervals.

3. The pressure-sensitive adhesive film according to claim 2, wherein the through-holes are arranged in at least the lengthwise direction at substantially equal intervals.

4. The pressure-sensitive adhesive film according to claim 3, wherein the through-holes are arranged in the lengthwise direction and the widthwise direction at substantially equal intervals.

5. The pressure-sensitive adhesive film according to claim 1, wherein a direction of a straight line connecting the through-holes adjacent to each other falls within a range of ±10° with respect to the lengthwise direction and/or the widthwise direction.

6. The pressure-sensitive adhesive film according to claim 1, wherein the through-holes are arranged is a dotted manner.

7. The pressure-sensitive adhesive film according claim 1, wherein a plan-view shape of each of the through-holes comprises a substantially circular shape or a substantially rectangular shape.

8. The pressure-sensitive adhesive film according to claim 1, further comprising a long separator temporarily bonded to the pressure-sensitive adhesive layer in a peelable manner.

9. The pressure-sensitive adhesive film according to claim 8, wherein the through-holes penetrate the separator, the resin film, and the pressure-sensitive adhesive layer integrally.

10. The pressure-sensitive adhesive film according to claim 1, wherein the pressure-sensitive adhesive film is wound in a roll shape.

11. The pressure-sensitive adhesive film according claim 1, wherein the pressure-sensitive adhesive film is bonded to a long film so that their lengthwise directions may be aligned with each other, and is used for selectively treating portions of the film corresponding to the through-holes.

12. The pressure-sensitive adhesive film according to claim 1, wherein the pressure-sensitive adhesive film is used for producing a long polarizer having a non-polarization portion.

13. The pressure-sensitive adhesive film according to claim 1, wherein peripheral edges of the through-holes on a pressure-sensitive adhesive layer side are each formed into an arcuate surface.
